(19) United States
(12) Patent Application Publication
(10) Pub. No.: US 2007/0235429 A1
(43) Pub. Date: Oct. 11, 2007

(54) Braze-welding of steel workpieces with copper wire and oxidizing gas mixture

(75) Inventors: Olivier Revel, Pierrelaye (FR); Olivier Dubet, Franconville (FR); Francis Briand, Paris (FR)

Correspondence Address: YOUNG & THOMPSON, 745 SOUTH 23RD STREET, 2ND FLOOR, ARLINGTON, VA, 22202, US

(73) Assignee: AIR LIQUIDE INDUSTRIAL US LP, HOUSTON, TX (US)

(21) Appl. No.: 11/709,243

(22) Filed: Feb. 22, 2007

(30) Foreign Application Priority Data
Mar. 15, 2006 (FR) 0650880

(51) Int. Cl. B23K 26/24; B23K 26/14

(52) U.S. Cl. 219/121.64; 219/121.84

(57) ABSTRACT

The invention relates to a process for the braze-welding of steel workpieces using a laser beam, for example of the Nd:YAG, CO₂, fibre or diode type, a consumable wire being the filler metal, and a gas mixture as gas shield, so as to produce a braze-welded joint between the workpieces. The consumable wire is based on copper and the gas mixture contains 40 to 60% oxygen and at least one gas chosen from argon, nitrogen and helium for the remainder.

The invention relates to a process for the braze-welding of steel workpieces, preferably made of coated steel, by a laser beam, in particular of the Nd:YAG type, with addition of metal via a copper-based consumable wire and with an appropriate oxidizing gas shield in place.

The process of “laser braze-welding” is a well-known welding process using a consumable wire and a laser beam generated by a laser generator, for example of the Nd:YAG type, in which the wire is melted by the laser beam so as to create a braze-welded joint between several metal workpieces to be joined together.

This process is mainly used in the automobile industry for assembling body parts, such as sunroofs, boots, etc., made of coated steel, i.e. hot-dip galvanized or electrogalvanized steel.

This process is appreciated in the industry for its advantages in terms of productivity, in particular rate of assembly and little finishing work required, and in terms of quality, namely attractive appearance, little deformation of the workpieces, limited degradation of the zinc protective surface layer, etc.

This process may be employed with or without a shielding gas.

However, in the absence of a gas shield, problems arise with the appearance of the weld bead obtained, especially a high roughness of the bead, deposition of smoke along the edges of the bead and a disturbed bead shape.

To avoid these problems, it is therefore preferable to carry out this process under a gas shield. Thus, the use of an inert shielding gas, such as argon, nitrogen or helium, makes it possible to obtain a smoother and generally cleaner bead, that is to say with less smoke deposition, than in the absence of gas.

However, the use of an inert gas results in a loss of productivity, in particular a reduction in the braze-welding speed.

In an attempt to remedy this, document WO-A-2004/014599 proposes the use of a gas mixture containing argon and one or more active compounds chosen from CO₂, oxygen, hydrogen and nitrogen in a proportion ranging up to 30% by volume, preferably CO₂, in order to braze-weld steel, aluminium or aluminium alloy workpieces.

However, the results obtained with this gas do not show a significant improvement in the weld bead thus obtained.

Moreover, document EP-A-1428604 proposes a process for brazing steel workpieces using a laser beam generated by a CO₂ laser device, a copper-based or bronze-based consumable wire being the filler metal, and a gas mixture as gas shield containing less than 2.5% active gas, 10 to 35% helium and argon for the remainder, so as to produce a braze-welded joint between said workpieces.

One problem that then arises is therefore how to improve the existing processes for braze-welding steel workpieces using a laser, in particular an Nd:YAG laser, so as to obtain a weld bead having an attractive surface appearance, and to do so without detriment to the productivity.

One solution is therefore a process for the braze-welding of steel workpieces using a laser beam, a consumable wire being the filler metal, and a gas mixture as gas shield, so as to produce a braze-welded joint between said workpieces, characterized in that:
the consumable wire is based on copper; and
the gas mixture contains 40 to 60% oxygen and at least one gas chosen from argon, nitrogen and helium for the remainder.

Depending on the case, the process of the invention may include one or more of the following features:
the gas mixture contains 45 to 55% oxygen;
the gas mixture contains about 50% oxygen;
the gas mixture contains argon;
the consumable wire is formed from a copper-silicon or copper-aluminium alloy;
the workpieces are made of coated steel;
the laser beam is obtained by means of a laser generator of the Nd:YAG, CO₂, ytterbium-doped fibre or diode type, or any other laser device capable of delivering a beam with a wavelength of 1.06 μm;
the gas is delivered by a nozzle having a recess or an orifice through which the laser beam passes;
the gas flow rate is between 5 and 30 l/min; and
the wire diameter is between 0.8 and 2.4 mm.

The process of the invention therefore is based on the combined use of an oxidizing gas of specific composition associated with a particular type of consumable wire based on copper, that is to say a wire that contains a non-negligible quantity of copper, in order to braze-weld steel workpieces, in particular those made of zinc-coated steel. The particular oxidizing gas/copper wire combination according to the invention very beneficially takes advantage of the absorption of the laser beam by the copper wire.

This is because the absorption of a laser beam by copper is normally limited, namely barely about 16.1% in the liquid phase (% of the incident energy of the laser beam). However, this absorption value increases if a highly oxidizing shielding gas is employed so as to form, on the surface of the metal exposed to the beam, an oxide that is much more absorbent than the original metal.

Owing to the compositional and distributional stability of the shielding gas stream, there is constant oxidizing and therefore a steady supply of energy to the filler metal. This makes it possible to achieve uniform melting of the filler metal.

The inventors of the present invention therefore had the idea of benefiting from these phenomena to improve the existing laser braze-welding processes.

Specifically, the combination of a copper-based filler metal and shielding gas comprising one or more inert gases, and more than 40% oxygen, typically a binary mixture formed from 50 vol % oxygen and 50 vol % inert gas, such as argon, nitrogen or helium, which gas is fed into the point of impact of the laser beam via an appropriate delivery nozzle, makes it possible, in laser braze-welding, thanks to the action of the oxygen on copper, to create an oxide that absorbs the laser beam better and thus to increase the performance in terms of productivity, that is to say speed and/or amount of filler metal melted, and in terms of quality, especially bead appearance and increased wetting.

Within the context of the invention, it is possible to use any gas delivery nozzle capable of forming a stable and reliable gas shield, and therefore achieving uniform oxidation of the filler metal.

In this regard, the lateral nozzle 3, in which a slot has been machined so as to let through the laser beam 1 which will melt the wire 2, described in document FR-A-0107245 and illustrated schematically in appended FIG. 4, is particularly well suited as it improves the constancy of the gas mixture delivered in the interaction zone, unlike certain conventional cylindrical nozzles that do not lead to an effective gas cover.

This is because it has been observed that, with such conventional nozzles, in certain configurations, the gas cover obtained may be contaminated by entry of ambient air, and therefore with atmospheric contaminants which will disturb the bead as it is being produced. This is explained by the fact that these conventional nozzles must generally be positioned set back in relation to the weld puddle, thereby permitting inopportune ingress of air into the gas shield.

In all cases, when the process is carried out, care has to be taken to contain the dispersion of the gas jet originating from the nozzle so as to obtain the most laminar and unidimensional flow possible at the surface of the metal sheets in the impact zone. Thus, the interaction zone will be perfectly shielded and the laser welding process will be even more effective.

In particular, using a nozzle according to FR-A-0107245, the laminar character of the gas flow beyond the mouth of the nozzle will be maintained thanks to the recessed end-piece of the nozzle through which the laser beam passes, the sidewalls of the end-piece providing additional guidance to the shielding gas.

In addition, with such a nozzle, it is possible to use a “hot” wire, that is to say a wire that has been preheated by Joule (resistance) heating, since in this way the gaseous environment may be controlled over the whole of the heated length of wire.

### EXAMPLE

To demonstrate the effectiveness of the process of the invention, comparative laser braze-welding trials were carried out using an Nd:YAG laser generator to generate the laser beam and copper-silicon (CuSi₃) consumable wires 1.6 mm in diameter as filler metal.

The welded workpieces were made of galvanized steel, that is to say with a surface coating of zinc 0.8 mm in thickness.

The shielding gas employed was an equivolume Ar/O₂ mixture according to the invention (trial E) or, if appropriate, gases according to the prior art (trials A to D). In trial B, the braze-welding was carried out without a shielding gas, and therefore in the ambient air.

The gas flow rates were 20 l/min and the pressure about 1 bar, that is to say slightly above atmospheric pressure. The gases were delivered by means of a recessed nozzle 1 as illustrated schematically in FIG. 4.

The results are given in the table below.

TABLE

| | | Laser | Welding | Wire | | |
|---|---|---|---|---|---|---|
| | | power | speed | speed | Bead | |
| Trial | Gas | (in kW) | (m/min) | (m/min) | appearance | Figure |
| A | Pure argon | 3 | 1.5 | 1.2 | Good | — |
| B | Air | 2.7 | 2 | 1.5 | Bad | 1 |
| C | Ar + 30% O₂ | 4 | 2.5 | 2.2 | Good | 2 |
| D | Ar + 20% CO₂ | 3 | 1.5 | 1.2 | Good | — |
| E | 50% Ar + 50% O₂ | 4 | 2.5 | 2.2 | Excellent | 3 |
| (invention) | | | | | | |

Bad: Rough surface appearance; smoke deposition on the edges of the bead; poorly “wetted” bead.
Good: Smooth bead; little smoke deposition on the edges of the bead; acceptable “wetting”.
Excellent: Very smooth bead; no smoke deposition; excellent wetting.

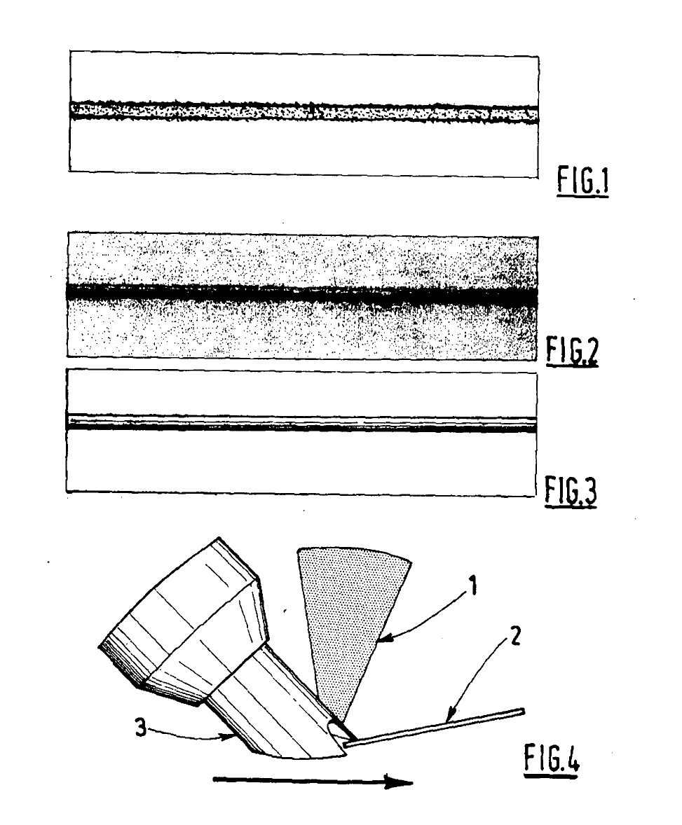

FIG. 1 shows the weld bead obtained in trial B, that is to say with no shielding gas, and therefore exposing the bead to the ambient air. It may be seen that the bead is of poor quality since it includes smoke deposits, it has a rough surface appearance and it is domed.

FIG. 2 shows the weld bead obtained in trial C, that is to say with a mixture according to the prior art, comprising an oxygen content of only about 30%. As may be seen, the bead obtained is not perfect as smoke deposits on the edges and surface irregularities are still observed.

FIG. 3 shows the weld bead obtained in trial E, that is to say with a mixture according to the invention. It may be seen that the bead has a very attractive surface appearance, with a smooth, stable and very shiny bead and no smoke deposits.

Moreover, when the welding speeds obtained (cf. table) are taken into consideration, the gas mixtures of the invention give the maximum welding speed, namely a speed of 2.5 m/min.

The process of the invention therefore makes it possible not only to increase the quality of the bead obtained but also to have a high welding speed, and therefore to maintain good productivity.

1. A process for the braze-welding of steel workpieces using a laser beam, a consumable wire being the filler metal, and a gas mixture as gas shield, so as to produce a braze-welded joint between the workpieces, characterized in that:
the consumable wire is based on copper; and
the gas mixture contains 40 to 60% oxygen and at least one gas chosen from argon, nitrogen and helium for the remainder.

2. A process according to claim 1, wherein the gas mixture contains 45 to 55% oxygen.

3. A process according to claim 1, wherein the gas mixture contains about 50% oxygen.

4. A process according to claim 1, wherein the gas mixture contains argon.

5. A process according to claim 1, wherein the consumable wire is formed from a copper-silicon or copper-aluminum alloy.

6. A process according to claim 1, wherein the workpieces are made of coated steel.

7. A process according to claim 1, wherein the laser beam is obtained by means of a laser generator of the Nd:YAG, CO₂, ytterbium-doped fibre or diode type.

8. A process according to claim 1, wherein the gas is delivered by a nozzle having a recess or an orifice through which the laser beam passes.

9. A process according to claim 1, wherein the gas flow rate is between 5 and 30 l/min.

10. A process according to claim 1, wherein the wire diameter is between 0.8 and 2.4 mm.

11. A process according to claim 2, wherein the gas mixture contains about 50% oxygen.

12. A process according to claim 2, wherein the gas mixture contains argon.

13. A process according to claim 3, wherein the gas mixture contains argon.

14. A process according to claim 2, wherein the consumable wire is formed from a copper-silicon or copper-aluminum alloy.

15. A process according to claim 3, wherein the consumable wire is formed from a copper-silicon or copper-aluminum alloy.

16. A process according to claim 2, wherein the workpieces are made of coated steel.

17. A process according to claim 2, wherein the laser beam is obtained by means of a laser generator of the Nd:YAG, CO₂, ytterbium-doped fibre or diode type.

18. A process according to claim 2, wherein the gas is delivered by a nozzle having a recess or an orifice through which the laser beam passes.

19. A process according to claim 2, wherein the gas flow rate is between 5 and 30 l/min.

20. A process according to claim 2, wherein the wire diameter is between 0.8 and 2.4 mm.
